(19) United States
(12) Patent Application Publication
(10) Pub. No.: US 2008/0043086 A1
(43) Pub. Date: Feb. 21, 2008

(54) Field Emission Based Photosensitive Drum for Image Forming Apparatus

(76) Inventors: Kuei-Wen Cheng, Guanyin Township (TW); Jeng-Ywan Jeng, Guanyin Township (TW); Te-Fong Chan, Guanyin Township (TW)

Correspondence Address: HDSL, 4331 STEVENS BATTLE LANE, FAIRFAX, VA, 22033, US

(21) Appl. No.: 11/464,858

(22) Filed: Aug. 16, 2006

(51) Int. Cl. B41J 2/39

(52) U.S. Cl. 347/141

(57) ABSTRACT

A photosensitive drum for image forming apparatus includes an inner roller, an outer roller and a photoelectric conversion layer. The inner roller of circular cylindrical shape is formed by a cathode substrate. The outer surface of the circular cylinder is configured with a plurality of cathode units. The outer roller of hollow circular cylindrical shape is formed by an anode substrate. The inner diameter of the outer roller is greater than that of the inner roller such that the inner roller is snugly fitted inside the outer roller. The anode substrate includes a plurality of anode units corresponding to the cathode units. The photoelectric conversion layer is a hollow circular cylinder with an inner diameter greater than the outer diameter of the outer roller such that photoelectric conversion layer is snugly fitted onto the surface of the outer roller. An electric potential difference is applied on the cathode substrate to induce the electron beam generated by the cathode unit to impinge on the anode unit to produce light. The generated light is directly converted into electrostatic by the photoelectric conversion layer to adsorb on the surface thereof to adsorb toner powder. The toner on the surface of the photosensitive drum is then transferred and fused on paper to form image.

### BACKGROUND OF THE INVENTION

1. Field of the Invention

The present invention relates to an electrographic image forming apparatus, and in particular, to a field emission based photosensitive drum for an image forming apparatus.

2. Description of Prior Art

The essence of the printing process of traditional laser printers lies in the repetitive operation of the photosensitive drum. The operation of laser printers generally includes the seven xerographic steps of charging, exposure, development, transferring, fusing, cleaning, and erasing.

When user initiates the printing process by instructing commands to the printer via computer application programs (as shown in FIG. 1), the xerographic process begins by the charging of charging unit 1a such that electrostatic charges are uniformly distributed over the surface of photosensitive drum 2a. Thereafter, an image signal representative of a text or image converted by the microprocessor within the printer is projected onto the surface of photosensitive drum 2a by a laser light beam 31a, which is generated by an external laser diode 3a. The regions of surface on the photosensitive drum 2a not illuminated by the laser light beam are referred to as “unexposed regions” with voltage potential unchanged. The regions of surface illuminated by the laser surface form “exposed regions”, such that the photosensitive drum converts the image signal into charges which distribute over the surface of photosensitive drum 2a. The revolving photosensitive drum 2a eventually comes into contact with the toner in the toner cartridge, and the toner particles are attracted (adsorbed) to the exposed regions of the photosensitive drum due to the charges existing thereon, and a visible image is thus created. When paper 5a fed into the printer comes into contact with the image developed on the surface of photosensitive drum 2a, due to charge differences, the toner image is transferred to the paper 5a. Meanwhile, the toner image is made to fuse on the surface of the paper 5a by high pressure and high heat through heater 6a. Thus, the paper coming right out the printer tray always feels warm. Then, photosensitive drum 2a is discharged and the remaining toner is removed from the surface by use of a cleaning unit 7a so the photosensitive drum 2a returns to initial conditions, and the next round of xerographic process can begin.

The low-cost field emission printer head, as disclosed in Taiwan Patent Publication No.367432, solves the problem associated with traditional LED array by alternatively utilizing field emission to create the external light required for exposure by the photosensitive drum printer head. The illumination provided for photosensitive drum exposure, by both the traditional method and the above-mentioned field emission based method, comes from an external source. Hence, the external light source must be precisely aligned such that the light is correctly projected onto the surface of the photosensitive drum and print quality degradation can be prevented. Also, both the former and latter methods are both electrically charged (approximately 6000 volts) by the external light source through electrically disassociating the air surrounding the photosensitive drum, but the drawbacks of both methods are the accompanying O₃ byproduct and the high energy required for disassociation.

### SUMMARY OF THE INVENTION

The invention is to provide a field emission based photosensitive drum. As the image is formed on the surface of the photosensitive drum, the surface of the photosensitive drum does not have to be charged and exposed by the external charging unit and the external light source respectively. Rather, the light is generated from an internal source by a field emission based device disposed within the photosensitive drum, and is directly converted to electrical energy that distributes over the surface of the photosensitive drum. Thus, when the photosensitive drum rotates and comes into contact with the toner in the toner cartridge, the toner powder can adsorb to the surface of the photosensitive drum by electrical attractions.

The invention provides a photosensitive drum for use by an image forming apparatus, comprising:

an inner roller of circular cylindrical shape formed by a cathode substrate, the outer surface of the circular cylinder being configured with a plurality of cathode units;

an outer roller of hollow circular cylindrical shape formed by an anode substrate, the inner diameter of the outer roller being greater than that of the inner roller, the inner roller being snugly fitted inside the outer roller, the outer surface of the hollow circular cylinder being configured with a plurality of anode units; and

a photoelectric conversion layer of hollow circular cylindrical shape, the inner diameter of the photoelectric conversion layer being greater than the outer diameter of the outer roller, the photoelectric conversion layer being snugly fitted onto the surface of the outer roller;

wherein the electron beam emitted by the cathode units impinges the corresponding anode units to cause light emission, the light generated by the anode units being converted by the photoelectric conversion layer into electrostatic to adsorb on the surface of the photoelectric conversion layer, for adsorbing toner.

### BRIEF DESCRIPTION OF THE DRAWINGS

FIG. 1 is schematic illustrating the internal configuration of a traditional laser printer;

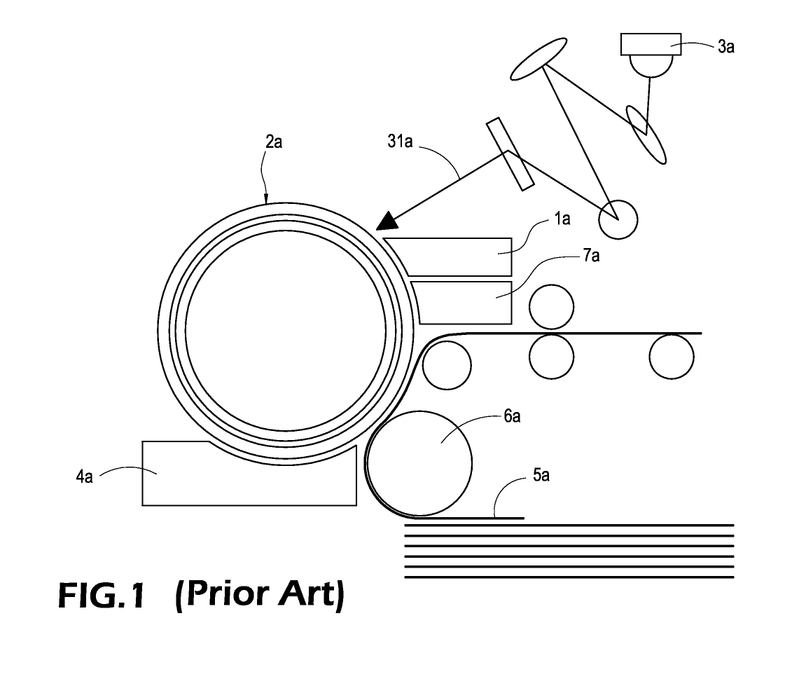

FIG. 2 is schematic illustrating the internal configuration of a field emission based photosensitive drum printer according to a preferred embodiment of the present invention;

FIG. 3 is schematic illustrating the filed emission based apparatus according to a preferred embodiment of the invention; and

FIGS. 4A-4C are schematics illustrating the process of fusing after the photoelectric conversion layer adsorbed toner.

### DETAILED DESCRIPTION OF THE INVENTION

The characteristics and the technical contents of the present invention will be explained with reference to the detailed description and the accompanying drawings. However, it should be understood that the drawings are illustrative but not used to limit the scope of the present invention.

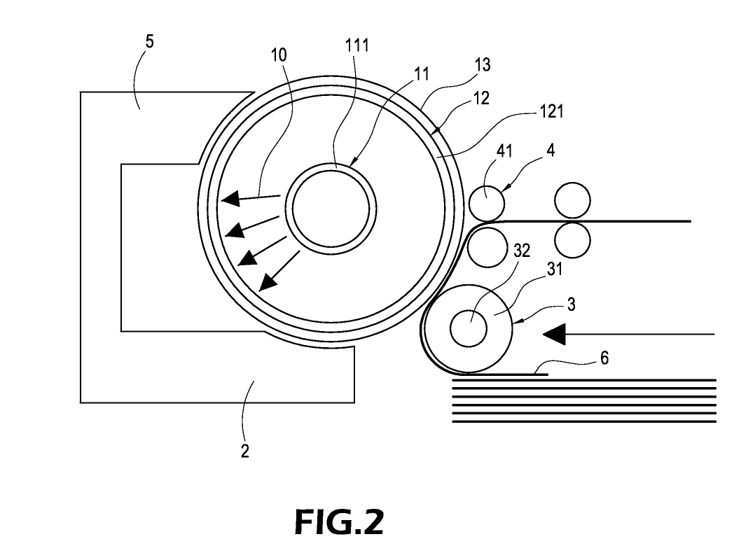

FIG. 2 is schematic illustrating the internal configuration of a field emission based photosensitive drum printer according to a preferred embodiment of the present invention. As shown in the figure, the printer of the present invention at least includes a photosensitive drum 1, a toner cartridge 2, a fusing unit 3, a roller assembly 4, and an erasing unit 5. Photosensitive drum 1 is manufactured with built-in field emission. Namely, the light is generated from within photosensitive drum 1 and converted into electrical energy such that the surface of photosensitive drum 1 is covered with electrostatic charges. When photosensitive drum 1 rotates and comes into contact with toner cartridge 3, toner powder is transferred to the surface of photosensitive drum 1 by electrostatic charge attraction. When the photosensitive drum 1 with toner powder then rotates and comes into contact with paper 6, the toner image is transferred to the surface of the paper 5a by fusing unit 3. Then, the remaining toner and electrostatic charges on the surface of photosensitive drum 1 is removed by erasing unit 5.

Photosensitive drum 1 includes an inner roller 11, an outer roller 12, and a photoelectric conversion layer 13. Inner roller 11 is a circular cylinder 111 formed by a cathode substrate. The outer surface of circular cylinder 111 is configured with a plurality of cathode units disposed in a matrix array (not shown). Outer roller is a hollow circular cylinder 121 formed by an anode substrate. The inner diameter of hollow circular cylinder 121 is greater than the outer diameter of inner roller 11, such that inner roller 11 is snugly fitted to the outer surface of outer roller 12. An electric potential difference is applied between inner roller 11 and outer roller 12, to cause the cathode unit of the cathode substrate to generate electron beam 10 which directly impinges the anode unit of outer roller 12 to generate light. The generated light is then converted by the photoelectric conversion layer 13, on the surface of which a layer of electrostatic is formed capable of adsorbing toner.

Toner cartridge 2 is disposed in correspondence with photosensitive drum 1. Fusing unit 3 is a roller wheel 31, and the interior of which contains a heating element 32. When paper 6 is fed in by roller wheel 31 and comes into contact with the toner adsorbed on the surface of photosensitive drum 1, both paper 6 and the toner are heated by heating element 32 of roller wheel 31, and the toner on the surface of photosensitive drum 1 is subsequently transferred and fused on the surface of paper 6 to form image.

Roller wheel assembly 4 is composed of a plurality of roller wheels 41 disposed in correspondence with above-described photosensitive drum 1. When image is formed on the surface of paper 6, paper 6 is output from the printer by roller wheels 41.

Erasing unit 5 is disposed in correspondence with photosensitive drum 1, for discharging the electrostatic. That is, when image is fused, photosensitive drum 1 rotates and comes into contact with erasing unit 6, the erasing unit 5 removes the remaining toner and electrostatic on the surface of photosensitive drum 1, allowing which to return to initial conditions and the next round of xerographic process can begin.

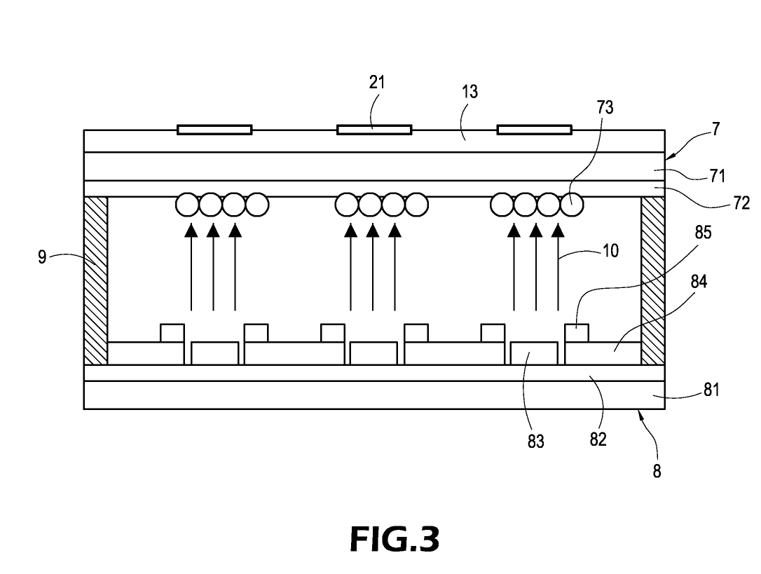

FIG. 3 is schematic illustrating the filed emission based apparatus according to a preferred embodiment of the invention. As shown in the figure, the above-mentioned light generated between inner roller 11 and outer roller 12 can be implemented by more than two electrodes of field emission based structure. In this preferred embodiment of the invention, a three-electrode field emission based structure is described. The structure includes an anode structure 7 and a cathode structure 8, and a spacer 9 lies therebetween to provide both vacuum spatial isolation and support. Anode structure 7 includes an anode substrate 71, an anode conduction layer 72, and a phosphors layer 73. The above-mentioned anode substrate 71 is constituted of conductive glass material. The anode conduction layer 72 is constituted of ITO (Indium Tin Oxide). The cathode structure 8 includes a cathode substrate 81, a cathode conduction layer 82, an electron emitter layer 83, a dielectric layer 84, and a gate electrode layer 85. Gate electrode layer 85 is applied an electric potential difference to induce the emission of electron beam 10 of electron emitter layer 83. Through the high voltage provided by anode conduction layer 72, electron beam 10 is accelerated to accrue enough momentum to impinge on the phosphors layer of anode structure 7 to cause illumination on the surface of anode substrate 71. The cathode conduction layer 82, electron emitter layer 83, dielectric layer 83, and gate electrode layer 85 shown in the figure collectively form a cathode unit, which is constituted of carbon nanotubes. The above-described anode unit is implemented using anode conduction layer 72 and phosphors layer 73.

After passing through anode substrate 71, the light is converted into electricity by photoelectric conversion layer 13 adhered on the surface of anode substrate 71. Hence, a layer of electrostatic charges capable of adsorbing toner 21 is formed on the surface of photoelectric conversion layer 13, solving the problem of O₃ pollution and power consumption caused by traditional laser printer while disassociating (electrolyzing) the air molecules surrounding the photosensitive drum during the charging process.

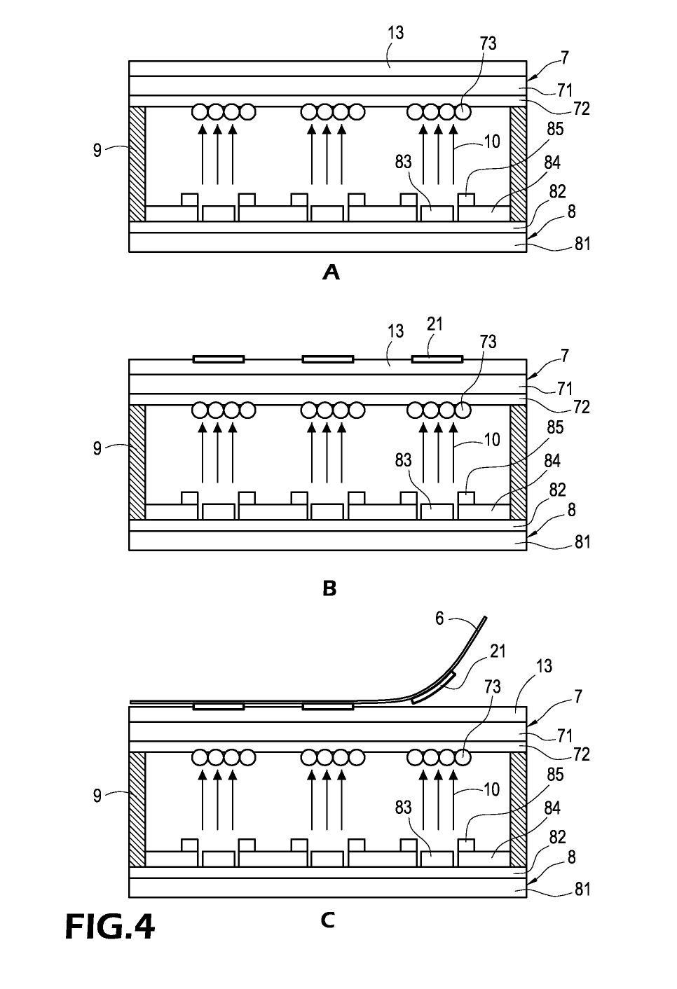

FIGS. 4A-4C are schematics illustrating the process of fusing after the photoelectric conversion layer adsorbed toner. Gate electrode layer 85 is applied an electric potential difference to induce the emission of electron beam 10 of electron emitter layer 83. The gate electrode layer 85 of substrate 81 is provided an electrical potential induce emission of the electron beam of electron emitter layer 83. Through the high voltage provided by anode conduction layer 72, electron beam 10 is accelerated to accrue enough momentum to impinge on the phosphors layer of anode structure 7 to cause illumination on the surface of anode substrate 71. After photoelectric conversion layer 13 converts light into electrical energy such that the surface of photoelectric conversion layer 13 is covered with electrostatic charges capable of adsorbing toner 21. When photoelectric conversion layer 13 rotates and comes into contact with paper 6, the toner image is then transferred and fused on the surface of paper 6.

Although the present invention has been explained in relation to its preferred embodiment, it is to be understood that many other possible modifications and variations can be made without departing from the spirit and scope of the invention as hereinafter claimed.

What is claimed is:

1. A photosensitive drum for image forming apparatus, for adsorbing toner to form images, the photosensitive drum comprising:
an inner roller of circular cylindrical shape formed by a cathode substrate, the outer surface of the inner roller being configured with a plurality of cathode units;
an outer roller of hollow circular cylindrical shape formed by an anode substrate, the inner diameter of the outer roller being greater than that of the inner roller, the inner roller being snugly fitted inside the outer roller, the outer surface of the outer roller being configured with a plurality of anode units; and
a photoelectric conversion layer of hollow circular cylindrical shape, the inner diameter of the photoelectric conversion layer being greater than that of the outer roller, the photoelectric conversion layer being snugly fitted onto the surface of the outer roller;
wherein the electron beam emitted by the cathode units impinges the corresponding anode units to cause light emission, the light generated by the anode units being converted by the photoelectric conversion layer into electrostatic to adsorb on the surface of the photoelectric conversion layer, for adsorbing toner.

2. The photosensitive drum as claimed in claim 1, wherein the cathode substrate includes a cathode conduction layer, an electron emitter layer, a dielectric layer, and a gate electrode layer formed thereon.

3. The photosensitive drum as claimed in claim 2, wherein the cathode conduction layer, the electron emitter layer, the dielectric layer, and the gate electrode layer collectively form the cathode unit.

4. The photosensitive drum as claimed in claim 2, wherein the electron emitter layer is constituted by carbon nanotubes.

5. The photosensitive drum as claimed in claim 1, wherein anode substrate includes an anode conduction layer and a phosphors layer formed thereon.

6. The photosensitive drum as claimed in claim 6, wherein the anode conduction layer and the phosphors layer collectively form the anode unit.

7. The photosensitive drum as claimed in claim 5, wherein the anode substrate is constituted of conductive glass material.

8. The photosensitive drum as claimed in claim 5, wherein the anode conduction layer is constituted of ITO (Indium Tin Oxide).

9. The photosensitive drum as claimed in claim 1, wherein a spacer is constructed between the anode substrate and the cathode substrate.
